(19) United States
(12) Patent Application Publication
(10) Pub. No.: US 2003/0052267 A1
(43) Pub. Date: Mar. 20, 2003

(54) Method for determining the molecular mass of constituents of a chemical element

(76) Inventor: Marcel Devienne, Cannes (FR)

Correspondence Address: James C Lydon, Suite 100, 100 Daingerfield Road, Alexandria, VA, 22314, US

(21) Appl. No.: 10/148,004

(22) PCT Filed: Sep. 28, 2001
(86) PCT No.: PCT/FR01/03009

(30) Foreign Application Priority Data
Sep. 29, 2000 (FR) 00/12465

(51) Int. Cl. H01J 49/26

(52) U.S. Cl. 250/282

(57) ABSTRACT

A method for determining the molecular mass M of at least a chemical element at the output of a mass spectrometer which includes a dissociation box where the ions of an element supplied by an ion source are dissociated into several fragments, an electrostatic analyzer where the fragments are subjected to an electric field so as to select fragments having a predetermined specific mass (mᵢ) according to the electric field and a detector for detecting the fragments at the output of the electrostatic analyzer. The method includes calculating a ratio between the masses of two unknown fragments for all the possible couples of fragment masses, comparing each of the ratios obtained with the mass ratios of standard fragments corresponding to the compounds currently obtained by dissociation of a particular element, and the determining the mass M of the element using the ratios of unknown fragments which are equal to the ratios of the standard fragments.

### TECHNICAL FIELD

The present invention relates to the chemical analysis of gaseous, liquid or solid compounds by mass spectrometry and to a method of determining the molecular mass of each constituent of a chemical compound.

### TECHNICAL DESCRIPTION

Currently, the analysis of a chemical compound, whether it is a simple compound or a mixture of simple compounds, requires the use of complex and expensive devices. With the existing analysis methods it is difficult to identify the constituents of the mixture of unknown compounds. Accuracy and reliability are often limited and their automation is difficult.

The engineer has perfected a detection and analysis apparatus that will deal with French patent n° 9602585, allowing the analysis of different molecules. It is constituted by the combination of different modules, each of which has one or several constituent elements of a mechanism that generates an energetic neutral molecular beam, a support or reception device of a sample to be analyzed and a filtering and detection device of secondary ions emitted by the compound forming the sample.

The problem however is to face with a quick and efficient determination the molecular masses of compounds forming the gaseous, liquid or solid sample, and to deduce the chemical formula of the above mentioned constituents.

### PATENT PRESENTATION

Goal of this patent is to realize a method in order to determine precisely and automatically the molecular mass of one compound from the detection of the mass of the dissociation fragments obtained at the exit of a mass spectrometry device.

Purpose of this patent is a determination method of molecular mass M of at least one chemical compound at the exit of the mass spectrometry including a dissociation box, in which the ions of the compound given by the ion source, moving at a speed clearly defined by the application of a potential difference, are dissociated into several fragments after having collided the molecules of a neutral gas, an electrostatic analyzer, in which the fragments are under an electrostatic field between two electrodes along a curving trajectory, in such a way that fragments having a specific mass m, can be selected according to the difference of the applied potential or of the electrostatic field, and a detector to detect the fragments at the exit of an electrostatic analyzer. This method includes the calculation of the ratio of the masses of two unknown fragments for all of the possible couples of the fragment masses, the comparison of each ratio obtained with the mass ratio of standard fragments corresponding to the compounds, which are frequently obtained by dissociation of any compound, and the determination of the mass M of a compound by the use of the mass ratios of known fragments, which are equal to the standard mass ratios.

### SHORT DESCRIPTION OF FIGURES

Goals, objects and other characteristics of the invention will be more clearly emphasized after reading the description of the figures:

FIG. 1 represents a mass spectrometry device adapted for the implementation of the patent

FIG. 2 is a bloc-diagram of a device represented in its functional form and allowing the use of method stages according to the patent.

FIG. 3 represents a calculation sheet that is giving the mass ratios of the unknown fragments taken two by two, detected in the mass spectrometry.

### DETAILED DESCRIPTION OF THE PATENT

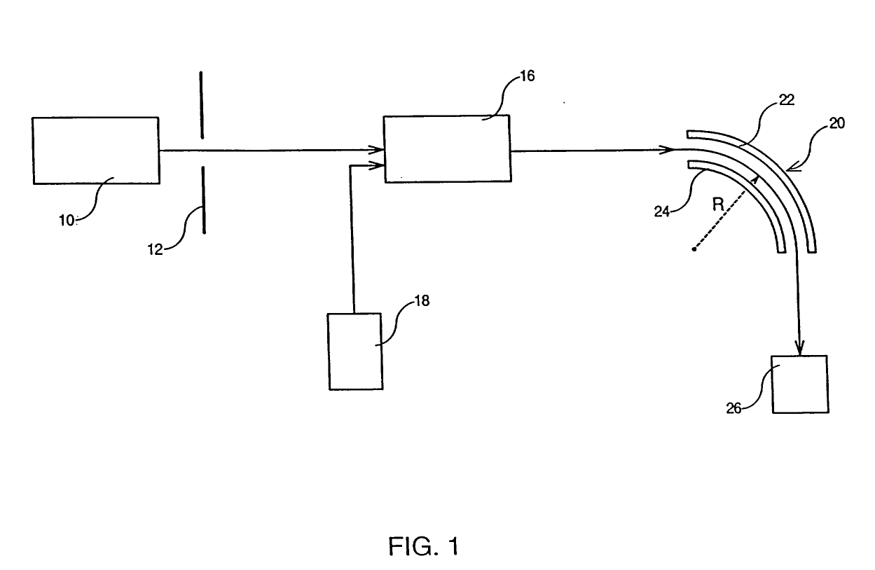

In reference to FIG. 1, a mass spectrometry adapted to the implementation of the patent first includes an ion source 10, which permits the extraction of ions under an extraction potential Vₒ provided by a generator device stabilized with a high tension 12. The extracted ions have therefore an energy which can be described by the formula:

Eₚ=eVₒ (1)

This energy can reach 10 keV or more.

We have to notice that the ions given by the ion source 10 can come from a liquid, gaseous, or solid substance and can be composed of one or several compounds, the molecular mass of which we want to determine.

If it is a liquid, it is vaporized to produce ions. If it is a solid, we obtain ions by bombardment of a sample with the use of the molecules of a neutral gas, such as krypton or argon.

The ions are then led to a dissociation box (16), in which the molecules to be analysed are broken into fragments by impacts, due to the molecules of a rare gas (krypton or argon) given by a molecular beam source of rare gas 18.

As the dissociation box 16 isn't under any potential at the time of the molecule fragmentation, the obtained fragments keep the same speed as the original constituents.

Assuming that a constituent to be determined has a molecular mass M, and each of the fragments has a mass m,, the kinetic energy of the constituent can be expressed by:

$${E}_{c} = \frac{1}{2} M {v}^{2}$$

The kinetic energy of each fragment being E_{c}', which has the value:

$$\frac{1}{2} {m}_{1} {v}^{2} , \frac{1}{2} {m}_{2} {v}^{2} , \frac{1}{2} {m}_{3} {v}^{2} , … \frac{1}{2} {m}_{i} {v}^{2} ,$$

depends on the fragment mass.

The ratio between the kinetic energy of a fragment mᵢ and the constituent of mass M is then:

$$\frac{{E}_{c}^{′}}{{E}_{c}} = \frac{{m}_{i}}{M} \qquad ( 2 )$$

As the kinetic energy E_{c} is equal to the energy of the constituent thanks to the application of the difference of potential Vₒ, we have then:

$$\begin{matrix}{E}_{c}^{′} = \frac{{m}_{i}}{M} \cdot {E}_{p} \\ {E}_{c}^{′} = \frac{{m}_{i}}{M} \cdot e \cdot {V}_{o}\end{matrix} \qquad ( 3 )$$

The fragments are then led to an electrostatic analyzer 20, electrodes 22 and 24 of which are separated by a distance d and a medium radius R and are both respectively submitted to potentials +Vₐₑ and −Vₐₑ. There is therefore an electrostatic radial field between the two electrodes that is equal to

$$E = \frac{2 Vae}{d}$$

In the electrostatic analyzer 20, each fragment of the mass is therefore subjected to an electrostatic force equal to:

$$\begin{matrix}{F}_{e} = eE \\ {F}_{e} = 2 e \frac{Vae}{d}\end{matrix} \qquad ( 4 )$$

and on the other hand to a centrifugation force equal to

$$\begin{matrix}{F}_{c} = \frac{{m}_{i} {v}^{2}}{R} \\ {F}_{C} = \frac{2 {Ec}^{′}}{R} \\ {F}_{c} = 2 \frac{e}{R} \cdot \frac{{m}_{i}}{M} \cdot Vo\end{matrix} \qquad ( 5 )$$

By varying the value of the potential Vₐₑ in order to sweep all the spectra, we determine for each fragment of mass mᵢ the value of the necessary potential, so that the fragment can go out the electrostatic analyzer and can be detected by detector 26, that is to say that the electrostatic force due to the potential Vₐₑᵢ balances the centrifugation force:

Fe=Fc

Then

$$2 e \cdot \frac{Vaei}{d} = 2 \frac{e \cdot {m}_{i}}{RM} \cdot {V}_{o}$$

We can deduce the ratio x_{i,}, equal to the ratio of the mass mᵢ of the fragment, compared to the mass of the constituent that is equal to:

$${x}_{i} = \frac{{m}_{i}}{M} = \frac{R \cdot Vaei}{{V}_{o}} \qquad ( 6 )$$

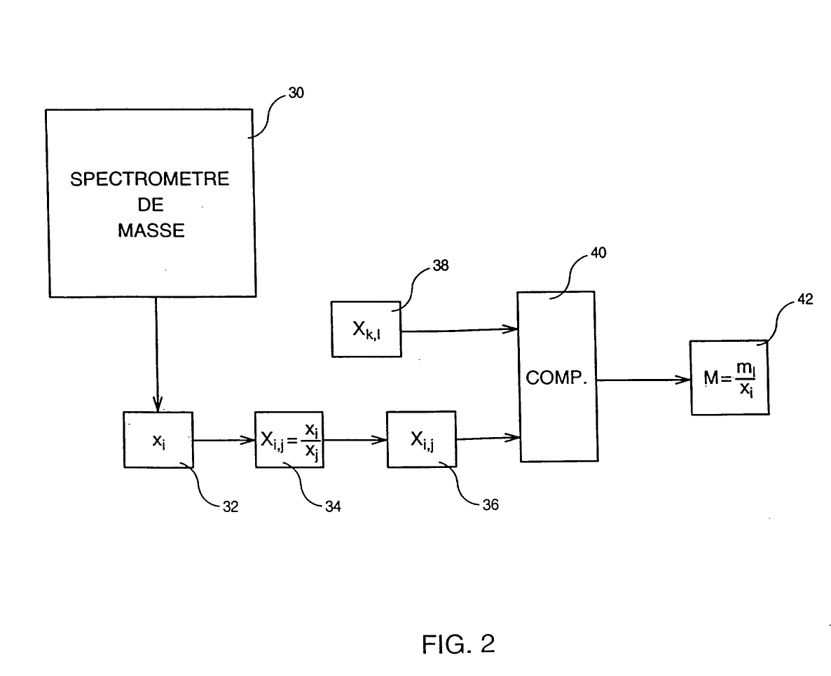

In reference to FIG. 2, we can determine a set of values xᵢ at the exit of the mass spectrometry 30 according to the values Vₒ and Vₐₑᵢ used, these values being recorded in a first memory 32. We have to note that, if the initial chemical compound consists of several constituents as it is often the case, there are several values of M we have to determine, and the set of xᵢ normally corresponds to the assembly of several subsets associated respectively to the various constituents.

The next operation consists in calculating, by means of calculation 34, the ratios of the values xᵢ, xⱼ taken two by two, i.e. one set of n(n+1)/2 ratios

$${X}_{ij} = \frac{{x}_{i}}{{x}_{j}}$$

Where xᵢ≦xⱼ and i or j varies from 1 to n, and in storing these ratios in a second memory 36.

Before going on, we have to precise that all the chemical compounds, which undergoes a fragmentation as it is mentioned above in reference to FIG. 1, are divided into fragments, the chemical formula of which we know. As a rule, these fragments, which will be called template fragments, are part of the following set : C, CH₂, N, NH, CH₃, NH₂, O, OH, NH₃, H₂O, C₂H₂, HCN, C₂H₃, CO, CNH₂, C₂H₄, CHO, CNH₃, C₂H₅, CH₂O, CNH₄, C₂H₆, CH₃O, C₃H₂, C₃H₃, C₃H₄, C₂H₀, C₃H₅, C₂NH₃ C₂H₂₀, C₂H₄N, C₃H₆, CONH, C₃H₇, CNH₅, C₂OH₃, CN₂H₃, CO₂, CONH₂, C₂OH₄, C₂NH₆, CO₂H, C₂OH₅, C₃H₂O, C₃H₄N, C₄H₆, C₃H₃O, C₄H₇, C₂H₂NO, C₃H₄O, C₄H₈, C₄H₉, C₃NH₇, C₂H₃NO, C₂H₂O₂, C₂H₄NO, CH₄N₃, C₂H₃O₂, C₂H₅NO, C₂ONH₆, C₂O₂H₄, C₃H₄N₂, C₄H₅O, C₅H₉, C₃H₂O₂, C₃ONH₄, C₄NH₈, C₅H₁₀, C₃H₃O₂, C₃H₅NO, C₄H₉N, C₃H₃S, C₃H₄O₂, C₃H₆NO, C₄H8O, C₄H₁₀,N, C₃H₅O₂, C₂H₅N₂O, C₃H₇NO, C₂H₄NO₂, C₂N₂OH₆, C₃ONH₈, C₂H₅NO₂.

As the molecular mass of each template fragments is known, it is easy to derive the mass ratios of the template fragments taken two by two as previously and to memorize these ratios in a third memory 38. Each ratio can be expressed by

$${X}_{k , l} = \frac{{m}_{k}}{{m}_{l}}$$

where mₖ and mᵢ are the masses of the template fragments.

The following stage consists in comparing, by means of comparison 40, between each ratio written in memory 36 and each of the ratios contained in the memory 38. When the ratios are equal, dial gauge 40 provides the value of the ratio by calculation 42 for the determination of the molecular mass M.

An equality between the ratios means:

$$\begin{matrix}{X}_{ij} = {X}_{k , l} \\ \frac{{x}_{i}}{{x}_{j}} = \frac{{m}_{k}}{{m}_{l}}\end{matrix} \qquad ( 7 )$$

If the corresponding fragments come from the same constituent of mass M, the above mentioned equality means that the mass of the fragment that we have to determine is equal to the mass of the template fragment, i.e.:

mᵢ=mₖ

or

mⱼ=mₗ

The computing by calculation 42 then consists in determining the value M by the equation:

$$M = \frac{{m}_{i}}{{x}_{i}} \qquad ( 8 )$$

As each constituent of mass M has produced several fragments of mass mᵢ (i varying from 1 to n), result of the comparison by dial gauge 40 permits to determine a first plurality of equalities corresponding to a mass M₁ of the first constituent, a second plurality of equalities corresponding to a mass M₂ of a second constituent and so on.

If, in a ratio Xᵢⱼ which has given an equality, each term xᵢ or xⱼ corresponds to a different constituent i.e.:

$${x}_{i} = \frac{{m}_{i}}{{M}_{1}} \text{and} {x}_{j} = \frac{{m}_{j}}{{M}_{2}}$$

It is clear that the computing by calculation 42, using the equation (8), leads to an erroneous result, the value of M found doesn't correspond to any real mass. Contrary to many results permitting to obtain real values of the masses of the constituents, this erroneous result is only obtained once or twice and can be eliminated, relying on the statistic principles.

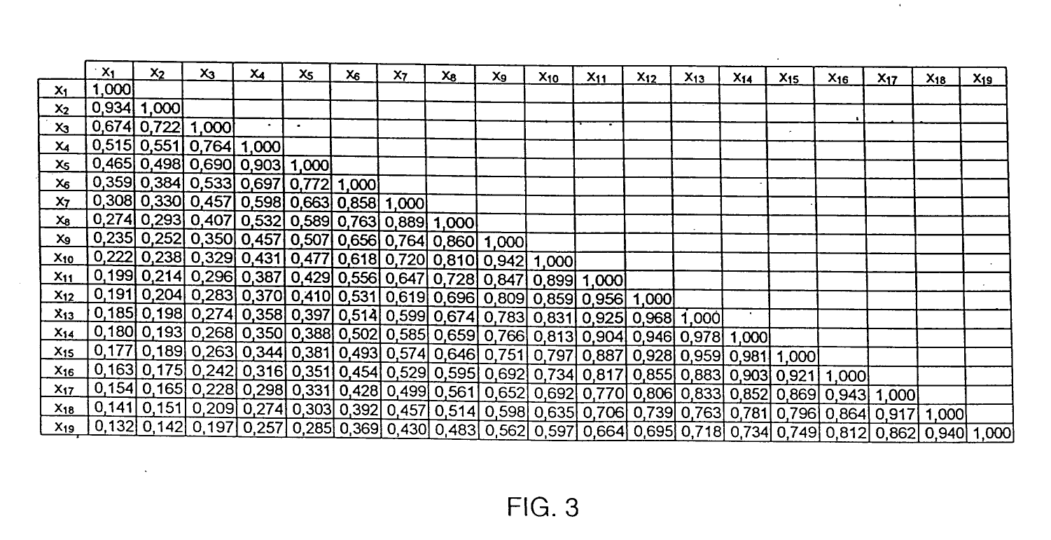

Following example will permit to understand better. We will suppose, a set of 19 values xᵢ has been obtained by detector 26 of FIG. 1. We can draw up the sheet with two entries in FIG. 3, giving the value of the ratio xᵢⱼ for each couple xᵢ,xⱼ.

We are determining that 6 ratios are giving a positive comparison, that is:

$$\frac{{x}_{1}}{{x}_{2}} = \frac{m ( {CH}_{2} )}{m ( {CH}_{3} )}$$

$$\frac{{x}_{1}}{{x}_{5}} = \frac{m ( {CH}_{2} )}{m ( {CH}_{6} )}$$

$$\frac{{x}_{1}}{{x}_{11}} = \frac{m ( {CH}_{2} )}{m ( {C}_{5} {H}_{10} )}$$

$$\frac{{x}_{2}}{{x}_{5}} = \frac{m ( {CH}_{3} )}{m ( {C}_{2} {H}_{6} )}$$

$$\frac{{x}_{2}}{{x}_{11}} = \frac{m ( {CH}_{3} )}{m ( {C}_{5} {H}_{10} )}$$

$$\frac{{x}_{5}}{{x}_{11}} = \frac{m ( {C}_{2} {H}_{6} )}{m ( {C}_{5} {H}_{10} )}$$

We are determining on this way four approximate values:

$${M}_{1} = \frac{m ( {CH}_{2} )}{{X}_{1}} = \frac{14.027}{0.132} = 106 , 265$$

$${M}_{2} = \frac{m ( {CH}_{3} )}{{X}_{2}} = \frac{15.035}{0.141} = 106 , 631$$

$${M}_{3} = \frac{m ( {C}_{2} {H}_{6} )}{{X}_{5}} = \frac{30.070}{0.284} = 105.880$$

$${M}_{4} = \frac{m ( {C}_{5} {H}_{10} )}{{X}_{11}} = \frac{70.135}{0.661} = 106.104$$

The average M of masses obtained on this way, for all the couples (mᵢ, xᵢ) permits to have a very good approximation of the real mass of the unknown compound:

$$M = \frac{( {M}_{1} + {M}_{2} + {M}_{3} + {M}_{4} )}{4} = \frac{106 , 265 + 106 , 631 + 105 , 880 + 106 , 104}{4} = 106 , 220$$

The examination of compound masses, closed to 106, shows that the constituent to be determined is O-Xylen, which has the formula C₈H₁₀ and has an exact molecular mass M=106.168.

We have to note, it is possible that the two ratios xᵢⱼ and x'ᵢⱼ are equal, and so, in the case of a positive comparison,

$$\frac{{x}_{i}}{{x}_{j}} = \frac{{x}_{i}^{′}}{{x}_{j}^{′}} = \frac{{m}_{k}}{{m}_{l}}$$

$$\frac{{m}_{i}}{{m}_{j}} = \frac{{m}_{i}^{′}}{{m}_{j}^{′}} = \frac{{m}_{k}}{{m}_{l}}$$

We can derive the molecular masses M₁ and M₂ of the two constituents

$$\text{1)} {m}_{1} = {m}_{k} \text{gives} {M}_{1} = \frac{{m}_{k}}{{x}_{i}}$$

$$\text{2)} {m}_{1 -}^{′} = {m}_{k} \text{gives} {M}_{2} = \frac{{m}_{k}}{{x}_{i}^{′}}$$

It is the same when ratios x_{k,l} and x'_{k,l} are identical. The same calculation as the one above shows that it leads to the determination of two molecular masses.

Different means 32 to 42 that are composing the system illustrated on FIG. 2 (putting aside mass spectrometry 30) can be realized by physical devices as processors with a specific goal, cabled logic units and some machines, which have end states. But the best way of realizing it, consists in using only one computer with a program composed of instructions in order to implement the stages of the method which has been described.

We have to note that, although the patent has been described by considering the example of an organic chemical compound, the method can also be used to determine the mass of an inorganic compound, template fragments being only different of those described above.

Furthermore, we can associate with the analyzed compound, a substance of same nature, which permits to obtain the mass values of the template fragments with more accuracy.

1. Method of determining the molecular mass M of at least one chemical compound at the exit of the mass spectrometry of the type comprising one dissociation box (16), in which the ions of this compound moving at a determined speed by the use of the potential difference are dissociated into several fragments after having crashing on the molecules of a neutral gas (18), an electrostatic analyser (20), in which these fragments are subjected to an electrostatic field between two electrodes (22,24) along the curved trajectory in order to select the fragments having a determined specific mass m, according to this difference of applied potential or of this electrostatic field, and a detector 26 to detect these fragments at the exit of this electrostatic analyser;
This method is characterised by following stages:
calculation of the ratio between the masses of two unknown fragments for all the possible couples of masses of these fragments,
comparison of each of these ratios obtained with the mass ratios of the standard fragments corresponding to the compounds that are normally obtained by dissociation of any compound and,
determination of the mass M of this compound by using the ratios of the unknown fragments that are equal to the ratios of the template fragments.

2. Method according to claim 1, in which detector (26) only detects the unknown fragments, for which the electrostatic force in this electrostatic analyzer (20) is balanced by the centrifugation force, due to the energy they have accumulated by the application of this potential difference before entering this electrostatic analyser.

3. Method according to claim 1 or 2, in which this detector (26) permits to detect the fragments of mass mᵢ, for which the ratio between this mass mᵢ and the above mentioned molecular mass M is a function of the applied electrostatic field Vₐₑᵢ in this electrostatic analyser (20) according to the equation:
$${x}_{i} = \frac{{m}_{i}}{M} = \frac{R}{d} \cdot \frac{{V}_{aei}}{{V}_{o}}$$
in which R is the average radius of the trajectory followed by the fragments in this electrostatic analyzer, d is the distance separating both electrodes of this electrostatic analyzer and Vₒ is the applied potential difference to these unknown fragments.

4. Method according to claim 3, in which the stage of determination of the molecular mass M of this compound consists, after having verified at comparison stage that the ratio of masses mᵢ and mⱼ of two unknown fragments is equal to the ratio of masses mₖ and mₗ of two standard fragments, in calculating M by the equation:
$$M = \frac{{m}_{1}}{{x}_{1}}$$

5. Method according to claim 4, in which M is considered as the value of the molecular mass of a constituent only if the result given by this stage of comparison has permitted to determine that a plurality of mass ratios of the unknown fragments is respectively equal to the plurality of the mass ratios of template fragments, and if this stage of determination of the molecular mass permits to determine the same mass M for each of these ratios.

6. Method according to claim 5, in which the fragments are not taken into consideration for determining the molecular mass M if there is no plurality of mass ratios of the unknown fragments, equal respectively to a plurality of mass ratios of the template fragments, but only some isolated cases of equality between these ratios.

7. System of determination of a molecular mass M of at least one chemical compound implementing the stages of the method according to one of claims 1 to 6 characterised in that it contains:
Means of calculation of the ratio between masses of two unknown fragments of this compound for all possible couples of masses of these fragments.
Means of comparison of each of these mass ratios.
Means of determination of the mass M of this compound by using the ratios of unknown fragments which are equal to ratios of template fragments.

8. Computer program comprising instructions, adapted to go through the stages of the method according to one of claims 1 to 6, as this program is executed on the computer.
